(19) United States
(12) Patent Application Publication
(10) Pub. No.: US 2008/0024004 A1
(43) Pub. Date: Jan. 31, 2008

(54) OIL BATH CAP FOR A TRACK ROLLER OF A TRACKED TRACTOR

(76) Inventors: Herb Rempel, Rosenort (CA); Ray Rempel, Rosenort (CA)

Correspondence Address: Mr. Adrian D. Battison;Ade & Company Inc., 2157 Henderson Highway, Winnipeg, MB, R2G 1P9, US

(21) Appl. No.: 11/781,343

(22) Filed: Jul. 23, 2007

Related U.S. Application Data
(60) Provisional application No. 60/833,248, filed on Jul. 26, 2006.

(51) Int. Cl. B62D 55/08

(52) U.S. Cl. 305/136

(57) ABSTRACT

A metal cap covers the open end of a sleeve, forming the hub of a roller for a tracked vehicle, to form en enclosed oil bath for the bearings where the cap includes on a center domed section a center opening covered by a transparent window for viewing of a level of oil in the bath and has a first and a second filler opening each closed by a screw plug where the filler openings are arranged generally on opposite sides of the center opening such that generally one of the openings will be available for filling above a horizontal line passing through the center of the domed section.

This application claims the benefit under 35 U.S.C. 119 of the priority date of Provisional Application 60/833,248 filed Jul. 26, 2006.

This invention relates to an oil bath cap for the hub of a track guide roller of the drive track of a tractor of the type having ground drive tracks.

### BACKGROUND OF THE INVENTION

One arrangement of tractor having ground drive tracks is the Case IH Quad Trac Tractor. This includes a series of drive rollers and idlers for each of the four tracks. Each one of these rollers has a tapered roller bearing set in its interior for supporting the roller for rotation on a support shaft where the bearings run in oil contained in a bath defined by the roller hub. There are four idlers and six rollers for each track making a total of 40 sets.

One example of an arrangement of this type is shown in U.S. Pat. No. 5,899,542 (Lykken) issued May 4, 1999 to Case Corporation, the disclosure of which is incorporated by reference.

The roller hub is closed by a cap which engages into the end of a sleeve surrounding the rollers. The cap includes a circular peripheral rim which presses against O-ring seals and is held in place by a split ring. The cap has a convexly domed wall inside the peripheral rim. Each cap has a plug to open and fill with additional oil if needed. The plug is screwed into a bore of the cap and is offset from the center of the dome. This means that the roller cap plug must be approximately on the vertical center line when it is removed to determine if the hub needs filling and the plug must be located above a horizontal center line, that is between 9 and 3 o'clock, to allow additional oil to be added. The checking procedure thus requires that each of the 40 rollers and idlers be rotated firstly to the vertical filling line to check the fill level and then the hub can be filled. This is of course a time consuming procedure which thus limits the regularity with which it can be carried out with the possibility of oil levels becoming too low and causing damage. Up to now no solution for this problem has existed.

### SUMMARY OF THE INVENTION

It is one object of the invention to provide an improved cap for use on the above rollers.

According to one aspect of the invention there is provided a roller for a tracked vehicle comprising:

a peripheral roller wall;

a hub carried on a support shaft for rotation about the shaft, the hub defining a sleeve with an open end;

bearings mounted between the hub and the shaft;

a metal cap sealing the open end of the sleeve to form en enclosed oil bath for the bearings;

the cap having a circular peripheral edge for sealing against the end of the sleeve and a domed center section;

wherein the cap includes on the domed section a center opening covered by a transparent window for viewing of a level of oil in the bath;

and wherein the cap has at least one filler opening closed by a screw plug where the at least one filler opening is arranged on one side of the center opening such that said at least one opening will be available for filling above a horizontal line passing through the center of the domed section.

Preferably the cap has a first and a second filler opening each closed by a screw plug where the filler openings are arranged generally on opposite sides of the center opening such that generally one of the openings will be available for filling above a horizontal line passing through the center of the domed section.

Preferably at least one of the plugs is magnetic.

There may of course be more than two filler openings including three arranged at 120 degree spacing and four arranged at 90 degree spacing around the center.

The arrangement can be used with driven and idler rollers of a tracked vehicle. The Case IH product is one example but the same cap may be used with other vehicles.

The invention therefore provides a cap that has two plugs instead of one and a hermetically sealed sight glass. So now checking can be done by walking past the 40 sight glasses and if any need filling, one of the 2 plugs will be in the right position above the center line to fill at any given tractor position. Added features may include a magnetic plug to collect metal particles from wear.

### BRIEF DESCRIPTION OF THE DRAWINGS

One embodiment of the invention will now be described in conjunction with the accompanying drawings in which:

FIG. 1 is an exploded view of the roller including the cap of the present invention.

FIG. 2 is an exploded view of the cap of the present invention.

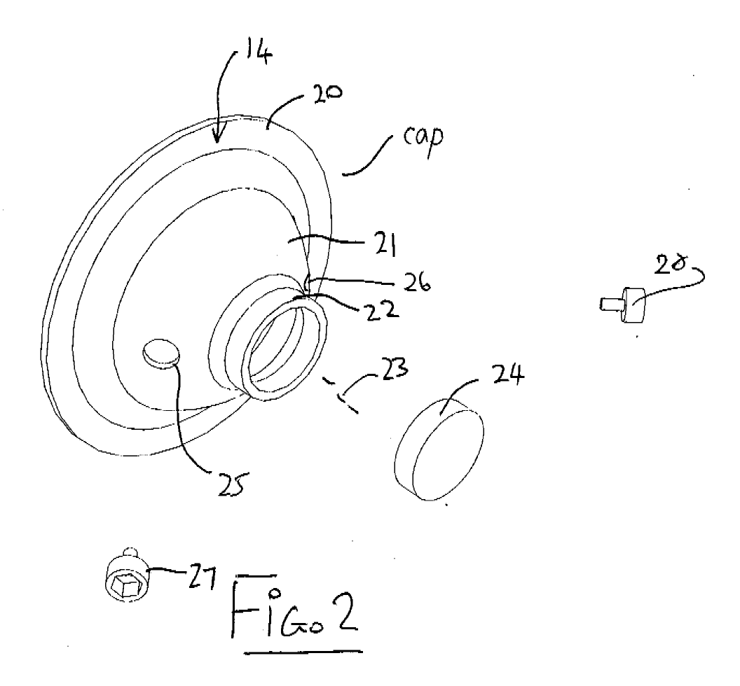

### DETAILED DESCRIPTION

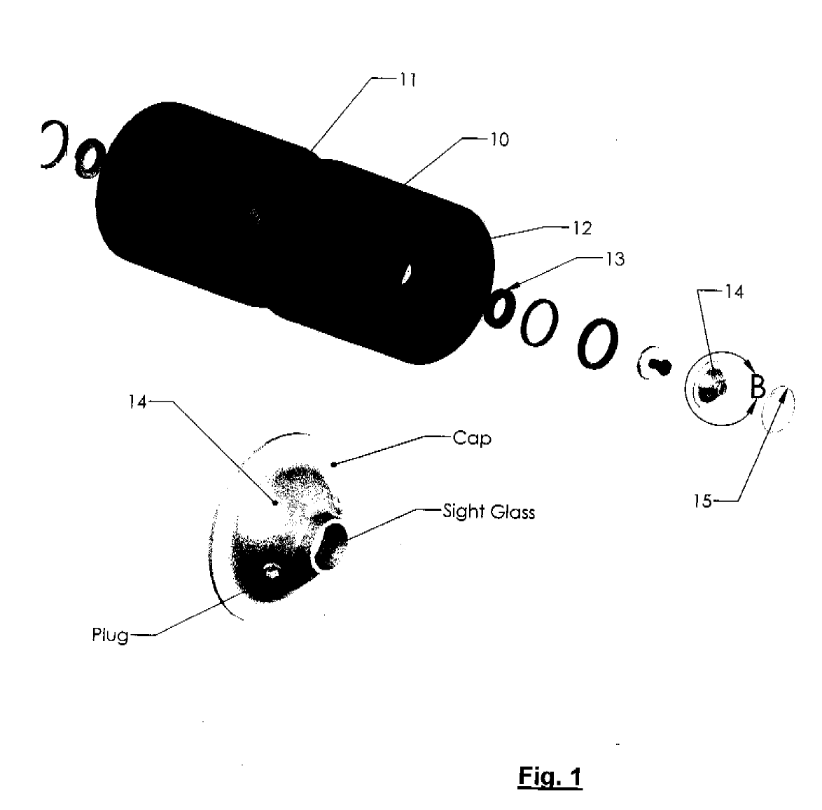

In FIG. 1 is shown a roller 10 for the above mentioned case IH cases Quad trac tractor which is well known to persons skilled in the art, and the design and construction of the tracks and rollers are also well known. The roller 10 thus includes a peripheral surface 1 1 for engaging the track and guiding the track. The roller includes a hub 12 in the form of a sleeve which surrounds shaft on which the roller is mounted for rotation. The end of the sleeve is closed by a series of sealing rings 13 and a cap 14 which is held in place by a split-ring or clip 15. The cap 14 has a peripheral rim 20 which is circular and is arranged to press against the sleeve at the end of the sleeve to seal against the sealing rings 13. The domed central section 21 is located inwardly of the peripheral rim 20 and extends from the rim inwardly to a center which is located centrally of the circular peripheral rim and projecting outwardly from that rim.

The domed section is shaped to define a collar 22 surrounding the center or central axis 23 of the cap. The collar 22 is closed by a transparent disk 24 of a suitable material which seals against the collar to close the cap. This acts therefore as a sight glass through which the interior can be viewed so as to see the level of oil sitting within the bath defined by the hub and cap. The oil has an edge meniscus thus lying against the sight glass so that the meniscus is visible to determine whether the level of the oil is above or below the central axis 23.

The cap 14 includes two openings 25 and 26 each of which is plugged by a threaded plug 27, 28. One or both of the plugs may be formed of a magnetic material or magnetized steel so as to act to draw any metal particles out of the oil to collect against the plug. The plugs are arranged diametrically opposed that is generally on opposite sides of the collar 22 relative to the axis 23.

Thus a user of the machine can simply view the level of the oil in the oil bath by viewing the oil through the sight glass and can then act to fill the bath with additional oil if necessary since one or other of the plugs and associated holes will in almost all cases be above the horizontal plane containing the center line 23 and thus available for filling. Only in very rare circumstances would there be two holes both lying on the horizontal center line or so close to the center that oil within the bath can escape from the hole when the plug is removed. In such a case it will be necessary to move the track sufficiently to rotate one of the holes to a position above the horizontal central line to allow the filling action to occur.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A roller for a tracked vehicle comprising:
a peripheral roller wall;
a hub carried on a support shaft for rotation about the shaft, the hub defining a sleeve with an open end;
bearings mounted between the hub and the shaft;
a metal cap sealing the open end of the sleeve to form en enclosed oil bath for the bearings;
the cap having a circular peripheral edge for sealing against the end of the sleeve and a domed center section;
wherein the cap includes on the domed section a center opening covered by a transparent window for viewing of a level of oil in the bath;
and wherein the cap has at least one filler opening closed by a screw plug where the at least one filler opening is arranged on one side of the center opening such that said at least one opening will be available for filling above a horizontal line passing through the center of the domed section.

2. The roller according to claim 1 wherein the cap has a first and a second filler opening each closed by a screw plug where the filler openings are arranged generally on opposite sides of the center opening such that generally one of the openings will be available for filling above a horizontal line passing through the center of the domed section.

3. The roller according to claim 1 wherein at least one of the plugs is magnetic.
